(19) United States
(12) Patent Application Publication
(10) Pub. No.: US 2009/0327165 A1
(43) Pub. Date: Dec. 31, 2009

(54) SYSTEM AND METHOD FOR RE-SUPPLYING ENERGY TO A BATTERY-POWERED ELECTRIC VEHICLE

(76) Inventor: Jonathan J. Kaufman, Brooklyn, NY (US)

Correspondence Address: DYKEMA GOSSETT PLLC, 39577 WOODWARD AVENUE, SUITE 300, BLOOMFIELD HILLS, MI, 48304-5086, US

(21) Appl. No.: 12/164,860

(22) Filed: Jun. 30, 2008

(51) Int. Cl. G06F 17/00

(52) U.S. Cl. 705/500; 320/109; 320/101

(57) ABSTRACT

A system for quickly and efficiently re-supplying electrical energy to an electric vehicle having a rechargeable battery of a certain type of battery within a geographic area is provided. The system comprises one or more service stations within the geographic area. The service station has a storage facility for another rechargeable battery of the same type and an automated handling device for removing the battery from the vehicle and inserting the other battery into the vehicle. In one embodiment of the invention, the system may further include a system for recharging the rechargeable battery from, for example, solar energy.

### FIELD OF THE INVENTION

The present invention relates generally to a system and method for re-supplying energy to a battery-powered electric vehicle in a manner that makes electric vehicle transportation practical, efficient and cost effective.

### BACKGROUND OF THE INVENTION

In the past several decades, vehicle travel has become a ubiquitous component of modern societies worldwide. During this same period automobiles and trucks have almost universally been powered by gasoline or diesel fuel. Recently, the market price of oil—as well as the costs of its derivatives gasoline and diesel—have increased significantly. This has made the cost of travel more and more expensive, leading for the first time in history to a decline in average daily car travel of a typical American.

Because of (i) the increased cost of petrochemical fuels like gasoline as noted above; (ii) concern regarding the availability of, and reliance on, foreign oil supplies; and (iii) environmental concerns such as greenhouse gases and global warming associated with combustion of petrochemical fuels, a search for alternative sources of energy and concomitantly non-gasoline/diesel powered vehicles has increased dramatically. For example, there is significant ongoing investigation of hydrogen fuel cell powered vehicles in which a fuel cell generates electric energy to power an electric motor directly. Because of cost and other factors, however, fuel cell powered vehicles are likely may years away from becoming practical.

One of the most promising alternative-fuel vehicles is the electric vehicle powered by a rechargeable electric battery (equivalently battery set or battery pack). The attractiveness of the battery-powered electric vehicle, besides the quietness of operation, is that the electric energy used to re-charge the battery can be generated by many sources, including petrochemical (e.g., oil, gas and coal used to power electric power generating stations), nuclear, as well as renewable energy sources such as solar, wind, and hydroelectric. However, the electric vehicle at present suffers from two significant drawbacks; the first is inconvenient while the second makes the battery-powered electric vehicle simply not viable as a replacement for today's gasoline- or diesel-powered vehicle.

The first drawback relates to the relatively limited range of present electric vehicles between charges. Present technology limits this range to about 100 miles, which is unattractive to today's drivers who have become accustomed to the 300 miles or so offered by a “full tank of gas.” However the range of electric vehicles has been increasing and is not as fundamental a limitation as some have implied.

The second drawback has been a more fundamental roadblock to electric vehicle adoption. This drawback is the excessively large time required for re-charging the battery or battery-set contained within a given electric vehicle. Most batteries used in electric vehicles are designed to be re-charged overnight. This means that once the range is attained, the “ride is over.” This fact has severely limited the acceptance of electric vehicles to a relatively modest number of exceptionally “green-minded consumers.” Some advances in higher-speed rechargeable batteries have been made recently. These technologies, however, are also not expected to be practical for many years.

Because of the modest practical advances made in re-charging times and range performance in electric vehicle batteries, the battery-powered electric vehicle remains a marginal part of the automobile market not only in the United States but throughout the world, despite the dramatic increase in gasoline prices.

### SUMMARY OF THE INVENTION

A system and method are provided for re-supplying electrical energy to an electric vehicle having a first rechargeable battery of a first type of battery within a geographic area.

A system in accordance with one embodiment of the present invention includes a first service station located within the geographic area. The service station has a storage facility for a second rechargeable battery of the first type of battery. The service station also has an automated battery handling device for removing the first rechargeable battery from the electric vehicle and inserting the second rechargeable battery into the electric vehicle.

A method in accordance with one embodiment of the present invention includes the step of providing a first service station within the geographic area, the first service station having a storage facility for a second rechargeable battery of the first type of battery and an automated battery handling device. The method further includes the steps of removing the first rechargeable battery from the electric vehicle with the automated battery handling device; and, inserting the second rechargeable battery into the electric vehicle with the automated battery handling device.

The invention is based on a remarkable insight of the present inventor, namely that it is not necessary to re-charge a depleted battery set in order to re-supply energy to an electric car; rather it is only necessary to remove the depleted battery set and replace it with a fully-charged battery, so that the delay associated with re-charging does not impact on the driver or passengers of the electric car. By eliminating the need for the vehicle operator or owner to recharge the battery and the resulting downtime for the vehicle, the invention increases the attractiveness and usefulness of electric vehicles because long range travel is permitted. The inventive system and method therefore offer several related advantages including a reduction in greenhouse-gas emissions and reliance on foreign energy sources.

With these and other objects and advantages in view, the present invention will be clearly understood from the ensuing detailed description in connection with the drawings.

### BRIEF DESCRIPTION OF THE DRAWINGS

FIG. 1 is a block diagram showing the interconnections of components of a system of the invention.

### DETAILED DESCRIPTION OF THE PREFERRED EMBODIMENT

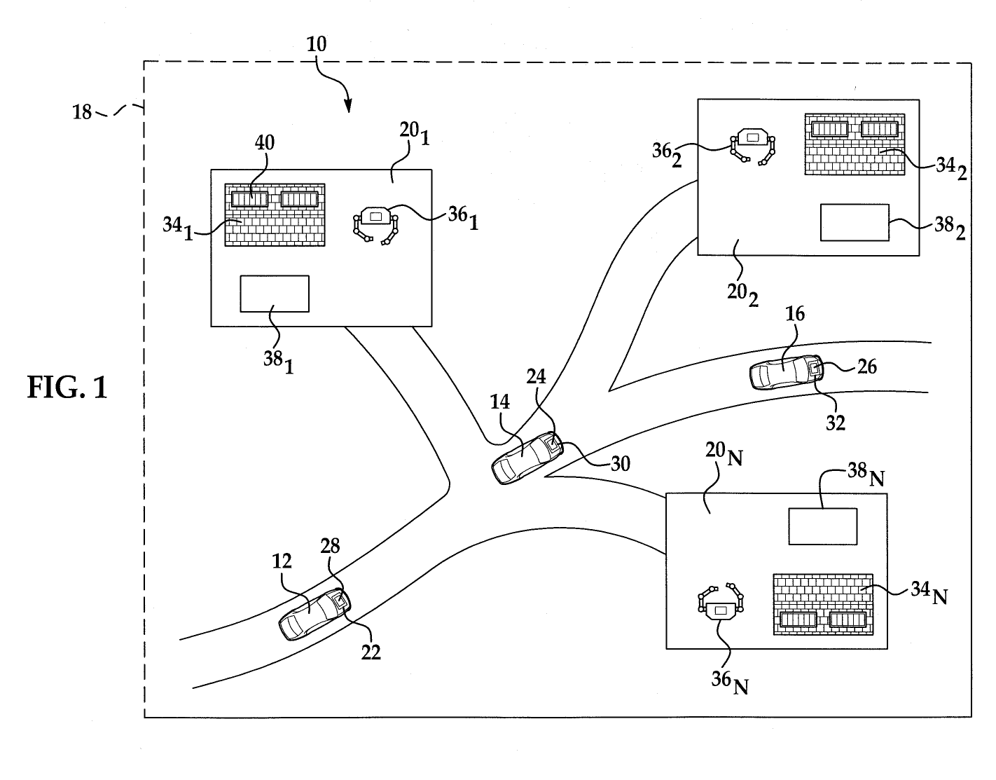

Referring now to the drawings wherein like reference numerals are used to identify identical components in the various views, FIG. 1 illustrates a system 10 for re-supplying electrical energy to one or more electric vehicles such as vehicles 12, 14, 16 within a geographic area 18. System 10 includes one or more service stations 20₁, 20₂, . . . , 20_{N} within the geographic area 18.

Vehicles 12, 14, 16 may comprise automobiles. It should be understood, however, that application of the invention is not limited to automobiles. Each vehicle 12, 14, 16 includes a corresponding battery 22, 24, 26. Batteries 22, 24, 26 may be of the same or different type (i.e., having the same or different structural and functional characteristics). For example, if vehicles 12, 14 are of the same make, model and year, batteries 22, 24 may be the same type as provided by the manufacturer. It is of course possible, however, that vehicles 12, 14 may have batteries 22, 24 of different types even if the same make, model and year (e.g., where increased battery power or range is an optional feature for a consumer). Similarly, even if vehicle 16 differs from vehicles 12, 14 (e.g., by make, model and/or year), vehicle 16 may have the same or a different type of battery 26 relative to batteries 22, 24.

Batteries 22, 24, 26 may be contained within containers 28, 30, 32, respectively, of a predetermined size and shape. Containers 28, 30, 32 may be used to facilitate removal and insertion/replacement of batteries 22, 24, 26 by standardizing the size and shape of the structures removed from and inserted into vehicles 12, 14, 16 as discussed hereinbelow. Containers 28, 30, 32 in one embodiment of the invention are rectangular parallelepiped epoxy boxes 30 cm×30 cm×50 cm in dimension and 1.5 cm in wall thickness. Two external terminals on each container 28, 30, 32 serve to connect the terminals of the corresponding battery 22, 24, 26 to the electrical circuitry in the electric vehicle 12, 14, 16. The same two terminals on the containers 28, 30, 32 also serve to connect the terminals of the corresponding batteries 22, 24, 26 to the recharging systems in the service stations 20₁, 20₂, . . . , 20_{N} discussed hereinbelow. It should therefore be appreciated that the two terminals of a battery 22, 24, 26 are connected electrically to the two terminals of a corresponding container 28, 30, 32. It should also be understood that containers 28, 30, 32 may assume a variety of sizes and shapes within the scope of the present invention.

Service stations 20₁, 20₂, . . . , 20_{N} provide a location for battery storage and removal and replacement of batteries 22, 24, 26. Service stations 20₁, 20₂, . . . , 20_{N} may also provide a location for recharging depleted batteries. Each of stations 20₁, 20₂, . . . , 20_{N} includes a storage facility 34₁, 34₂, . . . , 34_{N} and an automated battery handling device 36₁, 36₂, . . . , 36_{N}. Each of stations 20₁, 20₂, . . . , 20_{N} may further include a system 38₁, 38₂, . . . , 38_{N} for recharging depleted batteries.

Storage facilities 34₁, 34₂, . . . , 34_{N} may include a structure of suitable size and configuration to store one or more batteries. The facilities 34₁, 34₂, . . . , 34_{N} preferably are designed to protect batteries from outside environmental effects and therefore may be enclosed and subject to climate controls. Facilities 34₁, 34₂, . . . , 34_{N} may further include automated equipment (robots and conveyors) for movement of batteries within facilities 34₁, 34₂, . . . , 34_{N} and between facilities 34₁, 34₂, . . . , 34_{N} and external locations (including to and from devices 36₁, 36₂, . . . , 36_{N} and recharging systems 38₁, 38₂, . . . , 38_{N}).

Handling devices 36₁, 36₂, . . . , 36_{N} are provided for automated removal of batteries 22, 24, 26 from vehicles 12, 14, 16 and insertion of new batteries into vehicles 12, 14, 16. In the context of the present invention, “automated” means that handling devices 36₁, 36₂, . . . , 36_{N} perform at least one or more operations automatically in response to pre-programmed instructions, user inputs or a combination of the foregoing. Devices 36₁, 36₂, . . . , 36_{N} may, for example, comprise programmable robots that are designed to perform one or more tasks necessary for removal of batteries 22, 24, 26 and insertion of new batteries such as (i) obtaining access to batteries 22, 24, 26 within vehicles 12, 14, 16 (e.g., by opening a vehicle's hood), (ii) disconnecting electrical cables leading to batteries 22, 24, 26 (or containers 28, 30, 32), (iii) grasping and moving batteries 22, 24, 26 (or containers 28, 30, 32); (iv) retrieving, grasping, and moving new batteries into vehicles 12, 14, 16; (v) connecting electrical cables to batteries 22, 24, 26 (or containers 28, 30, 32); and (vi) closing access to the newly inserted batteries. In one embodiment of the invention, a robot model number IRB 6640 available from ABB Ltd., located in Zurich, Switzerland, is suitably adapted to serve as an automated handling device 36₁, 36₂, . . . , 36_{N}. It should be appreciated, however, that the invention may utilize a variety of automated handling devices 36₁, 36₂, . . . , 36_{N} for removal and insertion of batteries 22, 24, 26. These devices 36₁, 36₂, . . . , 36_{N} may, for example, include robots with machine vision for automatically locating a battery 22, 24, 26 in a vehicle 12, 14, 16. In one embodiment of the invention, battery containers 28, 30, 32 includes metallic markers that are used in conjunction with a robot arm equipped with machine vision to automatically locate the battery containers 28, 30, 32, which are subsequently removed and replaced with another container (containing another battery 22, 24, 26) by the robot arm. In general, it should be appreciated that a variety of embodiments of the automated handling devices 36₁, 36₂, . . . , 36_{N} can be realized by a person skilled in the art. For example, fully-automatic devices can be realized by autonomous robots as described in the excellent reference “Introduction to Autonomous Mobile Robots”, written by Roland Siegwart, Illah R. Nourbakhsh, Illah Reza Nourbakhsh and Illah Reza Nourbakhsh, published in 2004 by MIT Press located in Cambridge, Mass., the entire disclosure of which is incorporated herein by reference. Semi-automatic devices can be developed using robotic arms, as described in another excellent reference “Handbook of Industrial Robotics,” 2nd Edition, edited by Shimon Y. Nof, and published in 1999 by John Wiley and Sons, Inc. located in Hoboken, N.J., the entire disclosure of which is incorporated herein by reference. As already noted, the automated handling devices 36₁, 36₂, . . . , 36_{N} may also in certain embodiments incorporate machine vision, an excellent reference of which is provided in the “Handbook of Machine Vision,” edited by Alexander Hornberg and published in 2006 by John Wiley and Sons, Inc. (VCH) located in Hoboken, N.J., the entire disclosure of which is incorporated herein by reference.

Systems 38₁, 38₂, . . . , 38_{N} are provided to enable recharging of depleted batteries 22, 24, 26 removed from vehicles 12, 14, 16 (to enable the batteries 22, 24, 26 to be installed in another vehicle). Systems 38₁, 38₂, . . . , 38_{N} may include electrical conductors (e.g., wires or cables) and appropriately configured connectors to couple batteries 22, 24, 26 to an electric grid of a public or private utility provider. Alternatively, or in addition, systems 38₁, 38₂, . . . , 38_{N} may also include a device for converting energy into electricity and generating an electrical charge in the batteries 22, 24, 26. For, example, the device may comprise one more photovoltaic cells 40 used to convert solar energy into electricity. Cells 40 may, for example, be located on the roof of storage facilities 34₁, 34₂, . . . , 34_{N} or another structure at service stations 20₁, 20₂, . . . , 20_{N}. It should be understood that the structure and operation of the device may vary depending on the type of energy that is being converted to electricity. For example, the device may alternatively comprise a generator (petrochemical fuels) or a wind turbine (wind power), or may obtain electricity from a standard electrical grid.

The operation of system 10—and a method in accordance with the present invention—will now be described with further reference to FIG. 1. The inventive method includes the step or providing a service station such as station 20₁, within an area 18 with the service station 20₁ having a storage facility 34₁ for a battery of the type found in vehicle 12 and an automated battery handling device 36₁. The operator of vehicle 12 can enter the station 20₁ when the charge in battery 22 becomes depleted. The method further includes the step of removing the battery 22 from vehicle 12 using device 36₁. Vehicle 12 may be positioned at an appropriate location and orientation at station 20₁ to permit device 36₁ to act on vehicle 12 and remove battery 22 (or the container 28 containing battery 22). The method may further include the step of recharging battery 22. This step may include a substep of connecting the battery 22 to an electrical energy source such as an electric grid of a public or private utility provider and/or the substep of converting energy into electricity and generating an electrical charge in battery 22. In particular, system 38₁—and particularly cells 40—may be used to convert energy, such as solar energy, into electricity and generate an electrical charge in battery 22 while it is stored at station 20₁ following its removal from vehicle 12. The method further includes the step of inserting another battery into vehicle 12 with device 36₁. The battery may be retrieved from facility 24₁ and provided to device 36₁ which can then insert the battery (or container) within vehicle 12. Once the charged battery is installed, the vehicle operator can depart from service station 20₁ while the depleted battery 22 is recharged.

A system and method in accordance with the present invention offer several advantages. The invention permits electric vehicle operators to “refuel” their vehicles in a manner similar to gasoline or diesel powered vehicles and avoid the often substantial vehicle downtime required to recharge the vehicle battery. As a result, the useful range of electrical vehicles is substantially increased and the vehicles become a more practical and attractive option for consumers. The increased use of electric vehicles will further additional goals such as a reduction in greenhouse gases and environmental contamination and less reliance on foreign energy sources.

While several embodiments of the present invention have been disclosed hereinabove, it is to be understood that these embodiments are given by example only and not in a limiting sense. Those skilled in the art may make various modifications and additions to the preferred embodiments chosen to illustrate the invention without departing from the spirit and scope of the present contribution to the art. Accordingly, it is to be realized that the patent protection sought and to be afforded hereby shall be deemed to extend to the subject matter claimed and all equivalence thereof fairly within the scope of the invention.

What I claim is:

1. A system for re-supplying electrical energy to a first electric vehicle having a first rechargeable battery of a first type of battery within a geographic area, said system comprising:
a first service station located within said geographic area, said first service station having a storage facility for a second rechargeable battery of said first type of battery and an automated battery handling device for removing said first rechargeable battery from said electric vehicle and inserting said second rechargeable battery into said electric vehicle.

2. The system of claim 1 wherein said first service station includes a system for recharging said first rechargeable battery.

3. The system of claim 2 wherein said recharging system includes a device for converting energy into electricity and generating an electrical charge in said first rechargeable battery.

4. The system of claim 3 wherein said energy comprises solar energy.

5. The system of claim 1 wherein a first rechargeable battery of a second type of battery is stored in one of said storage facility or another storage facility at said first service station and one of said automated device and another automated device is configured to remove a second rechargeable battery of said second type of battery from another electric vehicle and insert said first rechargeable battery into said another electric vehicle.

6. The system of claim 1, further comprising a second service station located within said geographic area, said second service station having a storage facility for a third rechargeable battery of said first type of battery and an automated device for removing said first rechargeable battery from said electric vehicle and inserting said third rechargeable battery into said electric vehicle.

7. The system of claim 1 wherein said first and second rechargeable batteries are contained within first and second containers of the same predetermined size and shape.

8. A method for re-supplying electrical energy to a first electric vehicle having a first rechargeable battery of a first type of battery within a geographic area, said method comprising the steps of:
providing a first service station within said geographic area, said first service station having a storage facility for a second rechargeable battery of said first type of battery and an automated battery handling device;
removing said first rechargeable battery from said first electric vehicle with said automated battery handling device; and,
inserting said second rechargeable battery into said first electric vehicle with said automated battery handling device.

9. The method of claim 8, further comprising the step of recharging said first rechargeable battery.

10. The method of claim 9 wherein said recharging step includes the substep of converting energy into electricity and generating an electrical charge in said first rechargeable battery.

11. The method of claim 10 wherein said energy comprises solar energy.

12. The method of claim 8 wherein said a first rechargeable battery of a second type of battery is stored in one of said storage facility or another storage facility at said first service station and one of said automated device and another automated device is configured to remove a second rechargeable battery of said second type of battery from another electric vehicle and insert said first rechargeable battery into said another electric vehicle.

13. The method of claim 8, further comprising the step of providing a second service station within said geographic area, said second service station having a storage facility for a third rechargeable battery of said first type of battery and an automated battery handling device for removing said first rechargeable battery from said electric vehicle and inserting said third rechargeable battery into said electric vehicle.

14. The method of claim 8 wherein said first and second rechargeable batteries are contained within first and second containers of the same predetermined size and shape.
